(19) United States
(12) Patent Application Publication
(10) Pub. No.: US 2004/0136700 A1
(43) Pub. Date: Jul. 15, 2004

(54) Control system for repair arm curing device

(76) Inventor: Matthew H. Yackel, Brooklyn Park, MN (US)

Correspondence Address: Patrick S. Yoder, Fletcher, Yoder & Van Someren, P.O. Box 692289, Houston, TX, 77269-2289, US

(21) Appl. No.: 10/342,777

(22) Filed: Jan. 15, 2003

(51) Int. Cl. F26B 3/30

(52) U.S. Cl. 392/411; 392/415

(57) ABSTRACT

The present technique provides a system and method for curing a material, such as a finish coating. The system may have a closed-loop control coupled to an infrared curing device, wherein the closed-loop control is adapted to terminate a cure cycle if temperature feedback indicates an unresponsive over-bake or under-bake condition.

### BACKGROUND OF THE INVENTION

The present technique relates generally to finishing systems and, more particularly, to industrial finish curing systems. In specific, a system and method is provided for controlling an infrared curing cycle using temperature feedback.

Finish coatings, such as paint, are often applied to a product and subsequently cured via heating devices. For example, an infrared heating device may be used to heat a finish coating according to a curing cycle. The timing and accuracy of the temperatures within the curing cycle may be particularly important for attaining the desired material properties in the cured finish coating. Unfortunately, various curing cycle problems may lead to an over-bake or under-bake condition, which can alter the temperature profile of the curing cycle, damage the finish coating, and damage components of the curing system.

Accordingly, a technique is needed to address one or more of the foregoing problems.

### SUMMARY OF THE INVENTION

The present technique provides a system and method for curing a material, such as a finish coating. The system may have a closed-loop control coupled to an infrared curing device, wherein the closed-loop control is adapted to terminate a cure cycle if temperature feedback indicates an unresponsive over-bake or under-bake condition.

### BRIEF DESCRIPTION OF THE DRAWINGS

The foregoing and other advantages and features of the invention will become apparent upon reading the following detailed description and upon reference to the drawings in which:

FIG. 1 is a diagram illustrating an exemplary finishing system of the present technique;

FIG. 2 is a diagram illustrating an exemplary finish curing system of the present technique;

FIG. 3 is a flow chart illustrating an exemplary finishing and curing process of the system illustrated in FIGS. 1 and 2;

FIG. 4 is a perspective view illustrating an exemplary floor-mounted embodiment of the adjustable arm and curing device of the finish curing system illustrated in FIG. 2;

FIG. 5 is a side view illustrating an exemplary overhead embodiment of the adjustable arm and curing device of the finish curing system illustrated in FIG. 2;

FIG. 6 is a top view of the overhead embodiment of the adjustable arm and curing device illustrated in FIG. 5;

FIG. 7 is a flow chart of an exemplary temperature-feedback-controlled curing process of the present technique; and

FIGS. 8, 9, 10, and 11 are temperature versus time graphs illustrating exemplary curing cycles and temperature-feedback-controls of the present technique.

### DETAILED DESCRIPTION OF SPECIFIC EMBODIMENTS

The present technique provides a unique finishing system, which may be used to apply and/or cure a desired material on a target object. For example, a vehicle may be sprayed with a desired paint coating, which may be cured by one or more infrared (IR) curing devices. In this exemplary embodiment, a closed-loop control system with temperature-feedback is provided to ensure that the finishing system follows the desired curing cycle. For example, as discussed in detail below, the closed-loop control system may terminate the desired curing cycle if the temperature-feedback indicates a curing cycle problem, such as an over-bake condition, an under-bake condition, or a generally non-responsive operation of the curing device.

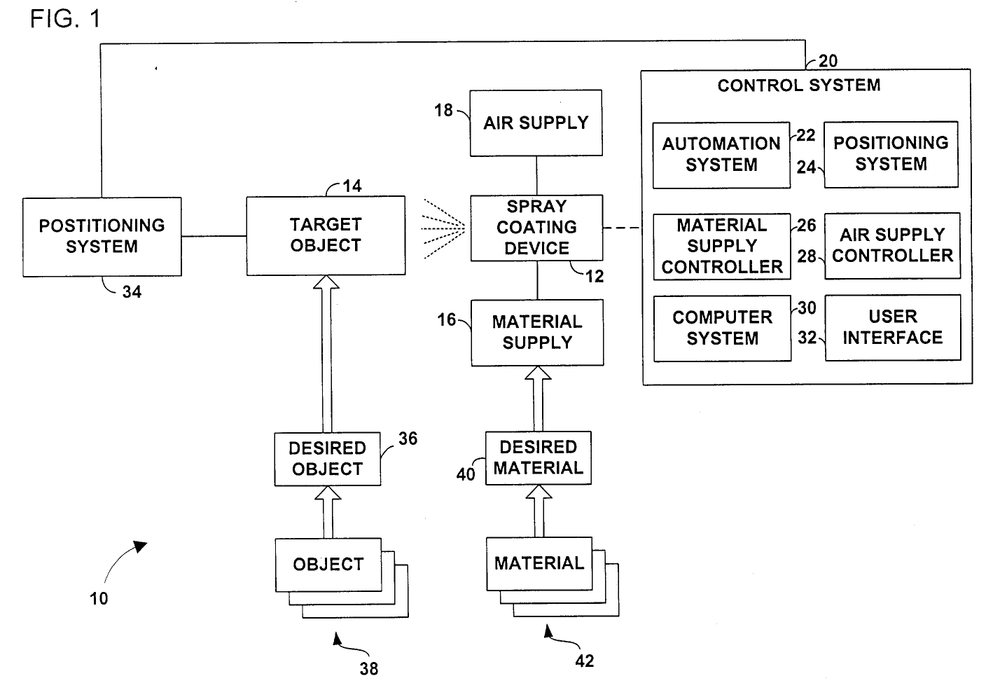

FIG. 1 is a flow chart illustrating an exemplary finishing system 10, which comprises a spray coating device 12 for applying a desired coating to a target object 14. For example, the spray coating device 12 may comprise an air atomizer, a rotary atomizer, an electrostatic atomizer, or any other suitable spray formation mechanism. The spray coating device 12 may be coupled to a variety of supply and control systems, such as a material supply 16 (e.g., a fluid or powder), an air supply 18, and a control system 20. The control system 20 facilitates control of the material and air supplies 16 and 18 and ensures that the spray coating device 12 provides an acceptable quality spray coating on the target object 14. For example, the control system 20 may include an automation system 22, a positioning system 24, a material supply controller 26, an air supply controller 28, a computer system 30, and a user interface 32. The control system 20 also may be coupled to a positioning system 34, which facilitates movement of the target object 14 relative to the spray coating device 12. For example, the positioning system 34 may comprise an assembly line, a hydraulic lift, a robotic arm, and a variety of other positioning mechanisms controlled by the control system 20. Accordingly, the finishing system 10 may provide a computer-controlled spray pattern across the surface of the target object 14.

The finishing system 10 of FIG. 1 is applicable to a wide variety of applications, fluid coating materials, powder coating materials, target objects, and types/configurations of the spray coating device 12. For example, a user may select a desired object 36 from a variety of different objects 38, such as different material and product types. The user also may select a desired material 40 from a plurality of different materials 42, which may include different coating types, colors, textures, and characteristics for a variety of materials such as metal and wood. For example, the desired material 40 may comprise a powder coating material, a fluid coating material (e.g., a paint), a filler material (e.g., body filler), and so forth. In one exemplary embodiment, the finishing system 10 may be incorporated into a vehicle assembly line or a vehicle repair facility.

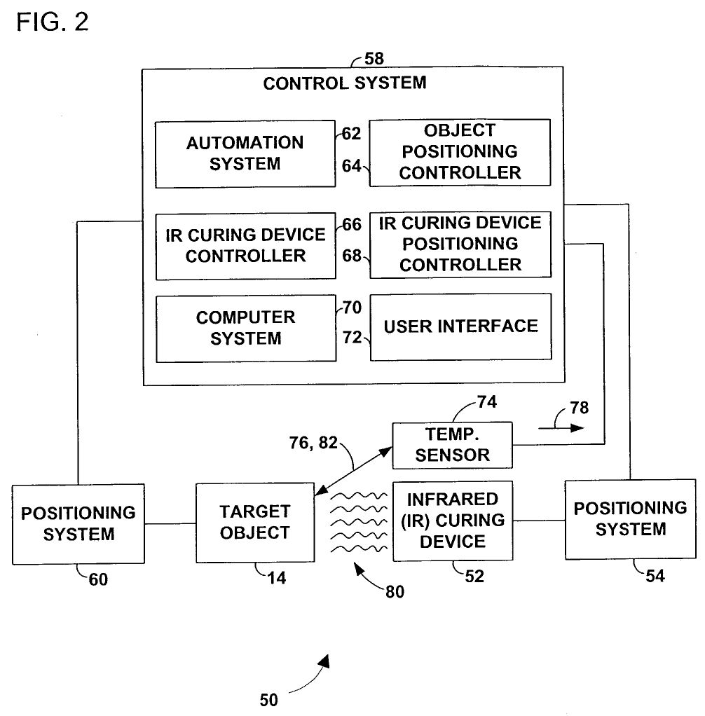

FIG. 2 is a diagram illustrating an exemplary finish curing system 50, which comprises a curing device 52 for curing a desired material applied to the target object 14. For example, the curing device 52 may comprise one or more heating devices (e.g., radiative heating mechanisms, such as infrared lamps), drying devices, or other suitable curing mechanisms. The curing device 52 also may be coupled to a positioning system, such as an adjustable arm 54, which positions the curing device 52 in a desired curing position relative to the target object 14. As discussed in detail below, the adjustable arm 54 may be coupled to a wide variety of stationary and mobile units, such as floor mounts, wall mounts, ceiling and overhead mounts, vehicle mounts, and so forth. The adjustable arm 54 and curing device 52 also may be incorporated into a variety of industrial finishing applications, such as assembly lines and repair facilities.

The finish curing system 50 also may include a variety of positioning and control systems (e.g., manual or automatic), such as control system 58 and object positioning system 60. The control system 58 ensures that the desired material is efficiently and optimally cured onto the target object 14. For example, the control system 58 may include an automation system 62, an object positioning controller 64, an infrared (IR) curing device controller 66, an infrared (IR) curing device positioning controller 68, a computer system 70, and a user interface 72.

As illustrated, the control system 58 is coupled to the object positioning system 60 and the infrared curing device positioning system 54 to facilitate movement of the target object 14 relative to the curing device 52. These positioning systems 60 and 54 may comprise a wide variety of manually-operated or automatically-controlled positioning systems, such as an assembly line, a hydraulic lift, or a robotic arm. In operation, the object positioning controller 64 controls movement of the positioning system 60 and corresponding target object 14, and the infrared curing device positioning controller 68 controls movement of the infrared curing device positioning system 54 and corresponding infrared curing device 52. The positioning controllers 64 and 68 and corresponding positioning systems 60 and 54 also may be controlled via the automation system 62. In each curing cycle or finish curing operation, the automation system 62 may provide computer-assisted control of the movement, timing, and general positioning of the target object 14 and/or the infrared curing device 52. Alternatively, the positioning controllers 64 and 68 and corresponding positioning systems 60 and 54 may be controlled via user intervention or other manual control.

Using the desired curing cycle or process, the infrared curing device controller 66 can interact with the infrared curing device 52 and a temperature sensor 74 (e.g., a pyrometer) to ensure the proper curing heats, durations, and general characteristics for the target object 14. The temperature sensor 74 may comprise a thermometer, a thermocouple, a thermistor, a radiation or optical pyrometer (e.g., an infrared pyrometer), or any other suitable temperature-sensing device. For example, the temperature sensor 74 may optically or radiatively communicate (arrow 76) with the target object 14 to provide temperature feedback 78 from the target object 14 (e.g., a surface coating), which is subject to infrared heat 80 from the infrared curing device 52. An aiming or targeting device 82 also may be used to direct an optical-type or radiative-type temperature sensor 74 toward the desired target object/surface. For example, an infrared pyrometer may be directed toward a desired target object/surface via a laser targeting device.

In operation, the infrared curing device controller 66 may command the infrared curing device 52 to increase, decrease, or hold the infrared heat output according to the desired curing cycle. For example, the infrared curing device controller 66 may transmit a ramp command(s) to the infrared curing device 52 to ramp the infrared red heat output to a desired temperature or power level at a desired rate or time duration. The infrared curing device controller 66 also may transmit a constant temperature command(s) to the infrared curing device 52 to maintain a desired temperature or power level for a desired duration, such as a constant temperature bake time. The infrared curing device controller 66 also may command the infrared curing device 52 to perform a variety of other time-constant or time-variable temperature profiles.

Using the temperature feedback 78 from the temperature sensor 74, the infrared curing device controller 66 may adjust one or more of the commands/control functions via closed-loop control, such that the desired curing cycle or profile is followed more accurately. Moreover, the infrared curing device controller 66 may use the temperature feedback 78 to terminate the desired curing cycle if a problem arises. For example, if the commands/control functions are not providing the intended temperature results on the target object 14, then the controller 66 may terminate the curing cycle. Although many problem conditions may arise in a given curing cycle, the infrared curing device controller 66 may trigger a loop-break in the curing cycle if problems arise with the temperature sensor, the curing device, or any other related device. For example, failure of the solid state relays for the curing device 52 may turn the curing device 52 to full power, thereby causing an over-bake condition. Another over-bake condition may be associated with a misalignment of the temperature sensor 74 (e.g., an optical or infrared pyrometer), which can cause a misreading of the temperature. Accordingly, the temperature feedback 74 and loop-break control reduces the likelihood of damage to the infrared curing device 52, the target object 14 and corresponding coating material, and various other devices potentially damaged by such problems.

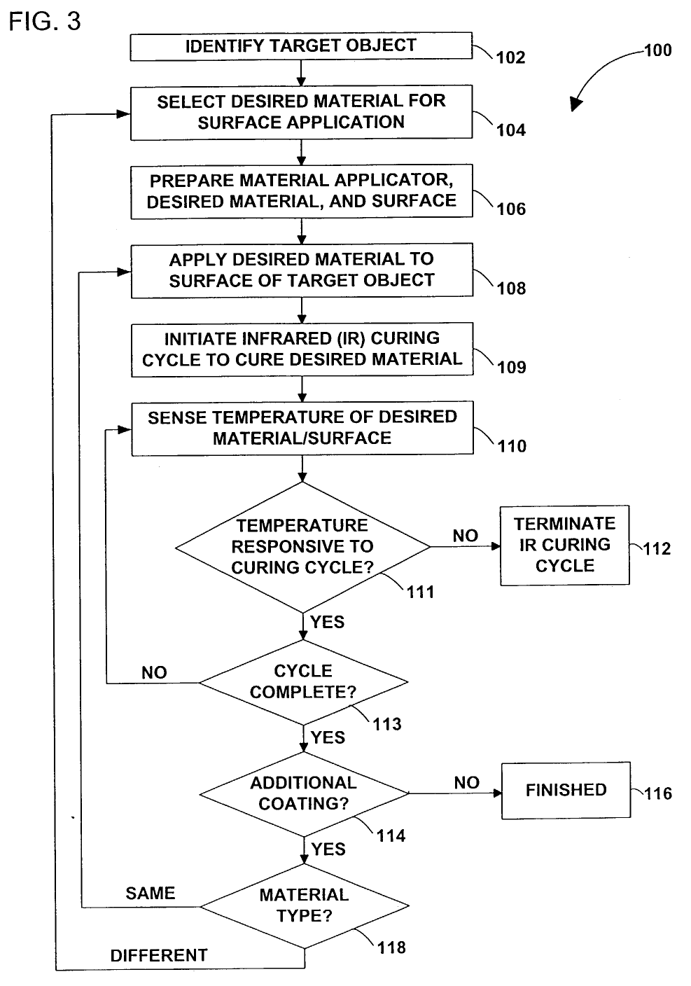

FIG. 3 is a flow chart of an exemplary finishing process 100 for applying and curing a desired material to the target object 14. As discussed above, the desired material may be a powder coating material, a fluid coating material, a filler material, or any other suitable surface material, including paints, varnishes, clear coats, fillers, top coats, and so forth. As illustrated, the process 100 proceeds by identifying the target object 14 for application of the desired material (block 102). The process 100 then proceeds by selecting the desired material 40 for application to a surface of the target object 14 (block 104). A user may then proceed to configure the material applicator (e.g., spray gun), prepare the desired material (e.g., liquid or powder paint), and prepare the target object/surface (block 106). The desired material may then be applied to the desired surface of the target object 14 (block 108). For example, paint may be applied to a surface of the target object 14 via a spray gun, such as a computer-controlled and operated spray gun.

The process 100 then initiates an infrared curing cycle to cure the desired maternal applied to the target object/surface (block 109). For example, the curing cycle may have one or more constant temperature periods, rising temperature periods, decreasing temperature periods, and so forth. Either continuously or at specific times during the curing cycle, the process 100 senses the temperature of the desired material applied to the target object/surface (block 110). For example, an optical pyrometer such an infrared pyrometer may be directed toward the target object/surface to acquire a temperature reading of the desired material during the curing cycle. The temperature reading may then be transmitted as temperature feedback to the curing control system (e.g., control system 58) for evaluation and adjustment of the curing cycle. For example, the process 100 may evaluate whether the sensed temperature is responsive to the curing cycle, i.e., commands provided by the curing control system (block 111). If the sensed temperature indicates variance from the curing cycle or non-response to commands from the curing control system, then the process 100 may terminate the infrared curing cycle at block of 112. As discussed above, the loop-break or curing-cycle-break at block 112 may reduce the likelihood or extend of damage to the finishing system, the target object, and the material applied to the target object/surface in the event of a curing cycle problem. If the sensed temperature correlates with the expected temperatures in the curing cycle, then the process 100 may proceed to query block of 113 for a determination of whether the curing cycle is complete.

If the curing cycle is not complete, then the process 100 continues to sense the temperature and determine whether the sensed temperature is responsive to the curing cycle (blocks 110 and 111). If the curing cycle is complete, then the process 100 may query for an additional coating at block 114. If an additional coating is not desired at block 114, then the finishing process 100 ends at block 116. If an additional coating is desired at block 114, then the process 100 queries for the desired material type at block 118. If an additional coating of the same material is desired at query block 118, then the process 100 returns to block 108 for application of the desired material to the target object/surface. If an additional coating of a different material type is desired at query block 118, then the process 100 returns to block 104 to select a different material for application to the target object/surface. The process 100 proceeds until the desired number of coatings is applied to the target object or, if a problem arises, the curing cycle breaks at block 112.

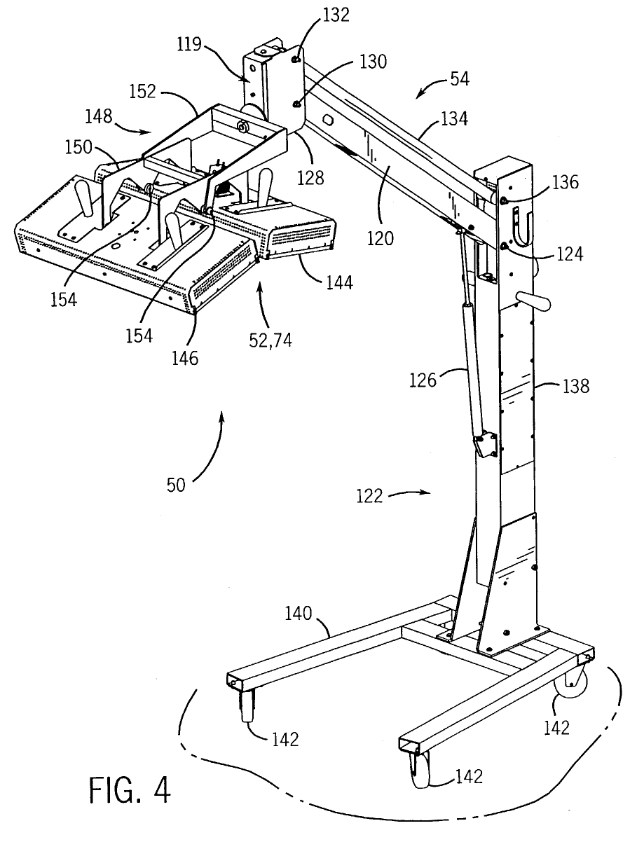

As described in further detail below, the foregoing systems 10 and 50 and the finishing process 100 may utilize a variety of positioning assemblies, such as the adjustable arm 54. FIG. 4 is a perspective view of an exemplary floor-mounted embodiment of the finish curing system 50 having the curing device 52 coupled to the adjustable arm 54 via an adjustable positioning mechanism 119. As illustrated, the adjustable arm 54 comprises an arm structure 120 rotatably coupled to an arm support 122 via a pivot joint 124.

Although the arm structure 120 is illustrated as a single straight arm, the adjustable arm 54 may have a multi-section arm and any suitable straight or curved geometry. The arm structure 120 also may have a variety of positioning control linkages to facilitate a desired vertical, lateral, and angular position. For example, the illustrated adjustable arm 54 has an arm positioning linkage 126 extending between the arm support 122 and the arm structure 120, such that the arm structure 120 may be moved vertically in a range extending between minimum and maximum vertical positions. The adjustable arm 54 also may have a variety of rotation-inducing mechanisms coupled to the arm structure 120, such that the arm structure 120 can be positioned in a desired angular position. In the illustrated embodiment, the adjustable arm 54 has an adjustable end structure 128 rotatably coupled to the arm structure 120 at a pivot joint 130. At an adjacent pivot joint 132, the adjustable end structure 128 is rotatably coupled to an end positioning linkage 134 that is rotatably coupled to the arm support 122 via a pivot joint 136. As described with reference to FIG. 2, each of the foregoing linkages may comprises a variety of manual or automatic motion-inducing mechanisms, such as a hydraulic mechanism, a pneumatic mechanism, a geared mechanism, a motorized mechanism, a cable and pulley mechanism, or any other suitable mechanism.

The illustrated arm support 122 includes a vertical support 138 extending from a base structure 140, which has a plurality of wheels 142. However, the arm support 122 may comprise any suitable fixed or movable structure depending on the particular application. For example, the arm support 122 may be bolted or generally secured to a wall, a floor, a vehicle, a trailer, or any other suitable vertical, horizontal, or angled mounting structure. The arm support 122 also may have a manual or automatic positioning system, such as a rotational or linear positioning system to move the arm support 122 adjacent the target object 14. Accordingly, the adjustable arm 54 can position the curing device 52 in a desired curing position relative to the target object 14.

The curing device 52, as illustrated in FIG. 4, includes a pair of heating/drying devices 144 and 146. The heating/drying devices 144 and 146 can have any suitable drying mechanism, such as conductive, convective, and radiative heat transfer mechanisms, which may cure a fluid coating, a powder coating, a filler, an adhesive, and so forth. For example, the heating/drying device 144 and 146 may comprise a fuel combustion heater, an electrical resistance heater, or an optical/light radiation heating mechanism, such as an infrared lamp. In this exemplary embodiment, the heating/drying devices 144 and 146 have infrared mechanisms. The heating/drying devices 144 and 146 are mounted to a head structure 148, which is coupled to the adjustable end structure 128 via the adjustable positioning mechanism 119. The illustrated head structure 148 has a fork-shaped extension 150 rotatably coupled to an E-shaped support 152 via a pivot joint 154. However, any suitable multi-section or integral support structure or yoke is within the scope of the present technique. The head structure 148 also may have a manual or automatic positioning system to pivot the E-shaped support 152 about the pivot joint 154.

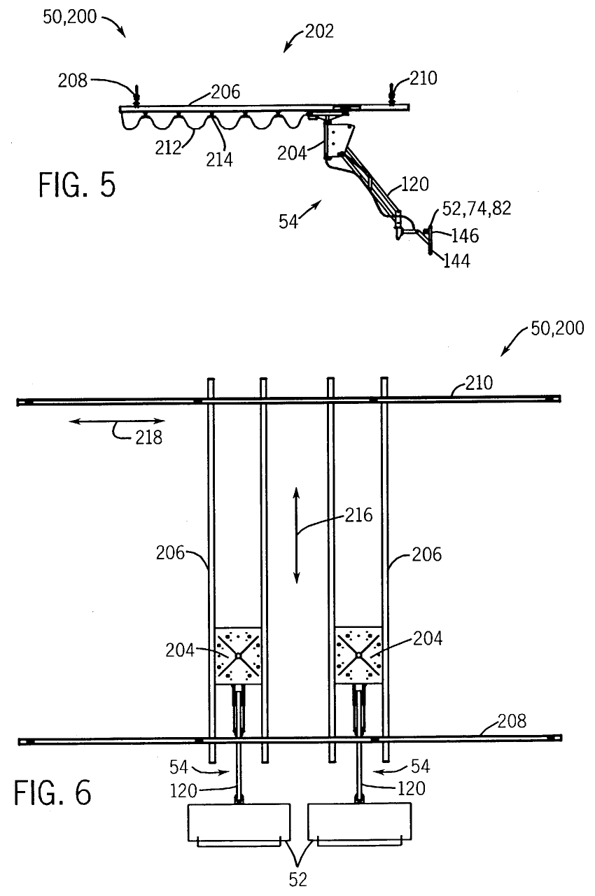

FIG. 5 is a side view of an exemplary floor-mounted configuration 200 of the finish curing system 50 having the curing device 52 coupled to the adjustable arm 54. In the illustrated embodiment, the adjustable arm 54 has the arm structure 120 coupled to an overhead mount 202 via a pivotal structure 204. The overhead mount 202 may comprise a variety of stationery and movable positioning systems, such as a ceiling mount, one or more rail structures, a hydraulic system, a cable and pulley system, a computer-controlled positioning system, a motorized-positioning system, and other suitable positioning mechanisms. As illustrated, the overhead mount 202 comprises an arm mount rail 206 movably coupled to a pair of parallel rails 208 and 210, such that two-dimensional motion is provided for the adjustable arm 54. One or more cables 212 also may be routed along the overhead mount 202 to the adjustable arm 54 via cable supports 214, such as cable hangers. For example, the cables 212 may comprise cables for the curing device 52 and the temperature sensor 74.

As discussed above, the present technique may comprise any suitable curing device 52 and temperature sensor 74. For example, the curing device 52 may comprise heating/drying devices 144 and 146, such as infrared heating lamps. The temperature sensor 74 may comprise an optical pyrometer, such as an infrared pyrometer. In operation, the adjustable arm 54 and the overhead mount 202 may be commanded to aim and position the curing device 52 closely to the target object, thereby facilitating a desired curing cycle for a surface coating. During the curing cycle, the temperature sensor 74 provides temperature feedback for evaluating and controlling the heating effects of the curing device 52 on the target object. If the temperature feedback indicates a problem in the curing cycle, then the present technique may terminate the curing cycle.

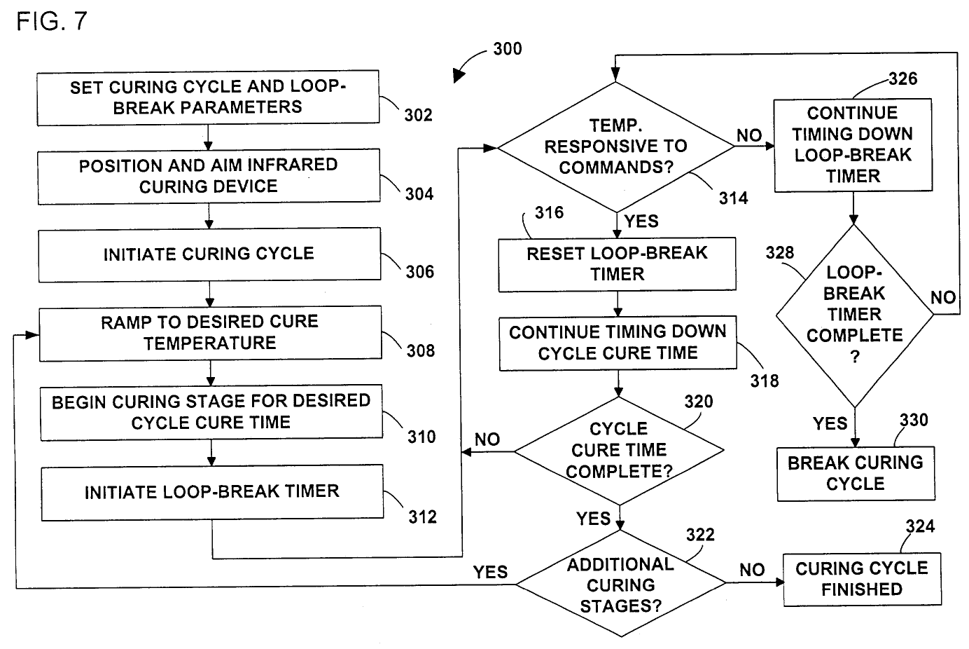

FIG. 6 is a top view illustrating an alternative embodiment of the floor-mounted configuration 200 of the finish curing system 50 having a pair of curing devices 52 and adjustable arms 54 mounted to arm mount rails 206 along the parallel rails 208. As illustrated, the adjustable arms 54 and curing devices 52 are movable along the arm mount rails 206 in a first linear path 216, while the arm mount rails 206 are movable along the parallel rails 208 and 210 in a second linear path 218 that is perpendicular to the first linear path 216. Accordingly, the rails 206 and 208 of the overhead mount 202 provide two-dimensional movement in an overhead plane, while the adjustable arms 54 provide movement in a third dimension extending away from the overhead plane.

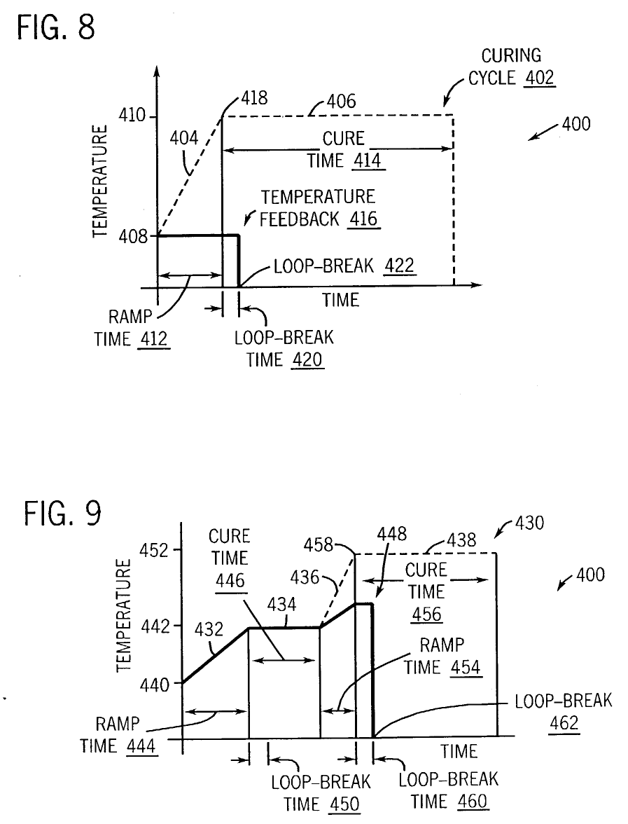

FIG. 7 is a flowchart illustrating an exemplary closed-loop or temperature-feedback-controlled curing process 300 in accordance with certain embodiment of the present technique. The curing process 300 may proceed by setting parameters for the curing cycle and loop-break (block 302). As discussed above, the curing cycle may comprise a variety of constant temperature, increasing temperature, and decreasing temperature stages, which operate to cure the desired material with the desired material characteristics (e.g., hardness, color, surface texture, etc.). Accordingly, the parameters for the curing cycle may comprise one or more target temperatures and time durations, such as ramp times and cure times. The loop-break parameters also may comprise one or more temperatures and times that trigger a loop-break in the curing cycle. Alternatively, the loop-break parameters may identify certain events, such as a lack of response to control commands, which trigger a loop-break in the curing cycle.

After setting the curing cycle and loop-break parameters, the process 300 positions/aims the infrared curing device toward the desired the target object/surface (block 304). The process 300 then initiates the desired curing cycle (block 306). At block 308, the curing process 300 ramps the temperature toward a desired cure temperature. The curing process 300 then begins a curing stage for a desired cycle cure time (block 310). The curing process 300 also may initiate a loop-break timer at block 312. For example, the loop-break timer may provide a closed-loop control-response time for the process 300 to control the infrared curing device and attain/maintain the desired cure temperature in the curing stage. As the loop-break timer proceeds, the curing process 300 may evaluate whether the temperature feedback from the target object/surface is changing in response to controller commands (block 314). The curing process 300 also may evaluate a variety of other parameters and problem indicators, such as temperature variance from the curing cycle.

If the curing process 300 determines that the temperature feedback is responsive to controller commands at block 314, then the curing process 300 resets the loop-break timer at block 316 and continues timing down the cycle cure time at block 318. The curing process 300 also may evaluate whether the cycle cure time is complete at block 320. If the cycle cure time is not complete at query block 320, then the curing process 300 returns to block 314 to evaluate whether the temperature feedback is responsive to controller commands. Otherwise, if the cycle cure time is complete at query block 320, then the curing process 300 queries for additional curing stages at block 322. If additional curing stages are desired at query block 322, then the curing process 300 returns to block 308 for an additional curing stage. However, if additional curing stages are not desired at query block 322, then the curing process 300 proceeds to finish the curing cycle at block 324.

If the curing process 300 determines that the temperature feedback is non-responsive to controller commands at block 314, then the curing process 300 continues timing down the loop-break timer at block 326 and evaluates whether the loop-break timer is complete at query block 328. If the loop-break timer is incomplete at query block 328, then the curing process 300 returns to block 314 to evaluate whether the temperature feedback is responsive to controller commands. If the loop-break timer is complete at query block 328, then the curing process 300 breaks the curing cycle at block 330. Accordingly, the curing process 300 may avoid potential damage (e.g., thermal damage) to components and materials by breaking the curing cycle in a non-responsive temperature-control condition.

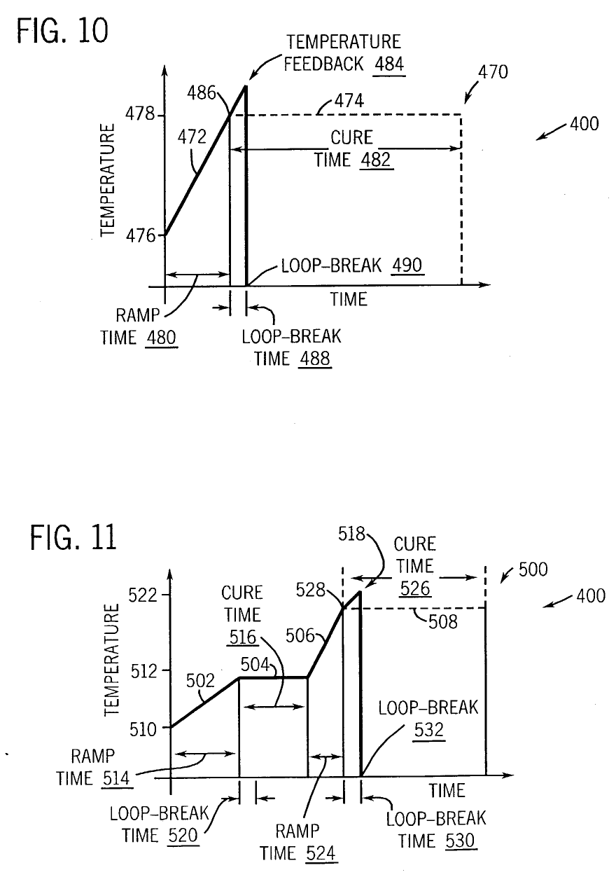

FIGS. 8, 9, 10, and 11 are temperature versus time graphs illustrating exemplary closed-loop temperature-feedback control systems 400, which may be used with the systems and processes 10, 50, 100, 200, and 300 described in detail above. Again, any suitable curing device, such as an infrared heating lamp, may be used within the scope of the present technique. As illustrated, the graphs of FIGS. 8 and 9 illustrate under-bake temperature control conditions, while the graphs of FIGS. 10 and 11 illustrate over-bake temperature control conditions.

FIG. 8 is a temperature versus time graph illustrating an exemplary curing cycle 402 having a ramp stage 404 and a cure stage 406. As illustrated, the ramp stage 404 controls the curing device 52 to increase the temperature from an initial temperature 408 to a desired cure temperature 410 over a ramp time 412. The cure stage 406 then controls the curing device 52 to hold the desired cure temperature 410 for a cure time 414. However, as discussed above, problems may arise in the execution of the curing cycle 402 that affect the actual temperature during the ramp and cure stages 404 and 406. Accordingly, the system 400 senses temperature feedback 416 to evaluate the actual temperature against the desired temperature profile of the curing cycle 402.

As illustrated, the actual temperature indicated by the temperature feedback 416 failed to respond from the start of the ramp stage 404. Accordingly, the temperature is below the desired temperature in the curing cycle 402, thereby creating an under-bake condition. In the illustrated embodiment, the system 400 evaluates the control-responsiveness of the curing cycle 402 at the end 418 of the ramp stage 404. For example, the system 400 may provide a loop-break duration or time 420 for the temperature controls to attain the desired cure temperature 410 in the cure stage 406. If the controls are able to adjust the temperature to the desired cure temperature 410, then the cure stage 406 can proceed and the system 400 may continue to evaluate the control-responsiveness of the curing cycle 402. However, in the illustrated condition, the controls are unable to increase the temperature to the desired cure temperature 410 within the loop-break duration or time 420. A loop-break control of the system 400 responds by terminating the curing cycle 402 at a loop-break 422.

FIG. 9 is a temperature versus time graph illustrating an exemplary curing cycle 430 having a first ramp stage 432, a first cure stage 434, a second ramp stage 436, and a second cure stage 438. As illustrated, the ramp stage 432 controls the curing device 52 to increase the temperature from an initial temperature 440 to a desired cure temperature 442 over a ramp time 444. The cure stage 434 then controls the curing device 52 to hold the desired cure temperature 442 for a cure time 446. However, as discussed above, problems may arise in the execution of the curing cycle 430 that affect the actual temperature during the ramp and cure stages. Accordingly, the system 400 senses temperature feedback 448 to evaluate the actual temperature against the desired temperature profile of the curing cycle 430. For example, the system 400 may evaluate the control-responsiveness of the curing cycle 430 at the end of the ramp stage 432. If a temperature-control problem is identified by the temperature feedback, then the system 400 may provide a loop-break duration or time 450 for the temperature controls to attain the desired cure temperature 442 in the cure stage 434. However, as indicated by the temperature feedback 448, a temperature-control problem does not exist in the illustrated ramp and cure stages 432 and 434.

Accordingly, the curing cycle 430 proceeds to the ramp stage 436, which transmits one or more commands to the curing device 52 to increase the temperature from the cure temperature 442 to another cure temperature 452 over a ramp time 454. Under normal operating conditions, the cure stage 438 would then hold the desired cure temperature 452 for a cure time 456. However, in the illustrated operating condition, the temperature feedback 448 indicates a temperature-control problem as the curing cycle 430 initiates the ramp stage 436. The system 400 identifies this temperature control problem by evaluating the control-responsiveness of the curing cycle 430 at the end 458 of the ramp stage 436. For example, the system 400 may provide a loop-break duration or time 460 for the temperature controls to attain the desired cure temperature 452 in the cure stage 438. Given the failure of the controls to increase the temperature to the desired cure temperature 452 within the loop-break duration or time 420, a loop-break control of the system 400 responds by terminating the curing cycle 430 at a loop-break 462.

FIG. 10 is a temperature versus time graph illustrating an exemplary curing cycle 470 having a ramp stage 472 and a cure stage 474. As illustrated, the ramp stage 472 controls the curing device 52 to increase the temperature from an initial temperature 476 to a desired cure temperature 478 over a ramp time 480. The cure stage 474 then controls the curing device 52 to hold the desired cure temperature 478 for a cure time 482. However, as discussed above, problems may arise in the execution of the curing cycle 470 that affect the actual temperature during the ramp and cure stages 472 and 474. Accordingly, the system 400 senses temperature feedback 484 to evaluate the actual temperature against the desired temperature profile of the curing cycle 470.

As illustrated, the actual temperature indicated by the temperature feedback 484 failed to respond to controls from the cure stage 474. Accordingly, the temperature continued to ramp upwardly beyond the desired cure temperature 478, thereby creating an over-bake condition. In the illustrated embodiment, the system 400 evaluates the control-responsiveness of the curing cycle 470 at the end 486 of the ramp stage 472. For example, the system 400 may provide a loop-break duration or time 488 for the temperature controls to attain the desired cure temperature 478 in the cure stage 474. If the controls are able to adjust the temperature to the desired cure temperature 478, then the cure stage 474 can proceed and the system 400 may continue to evaluate the control-responsiveness of the curing cycle 470. However, in the illustrated over-bake condition, the controls are unable to decrease or level off the temperature to the desired cure temperature 478 within the loop-break duration or time 488. A loop-break control of the system 400 responds by terminating the curing cycle 470 at a loop-break 490.

FIG. 11 is a temperature versus time graph illustrating an exemplary curing cycle 500 having a first ramp stage 502, a first cure stage 504, a second ramp stage 506, and a second cure stage 508. As illustrated, the ramp stage 502 controls the curing device 52 to increase the temperature from an initial temperature 510 to a desired cure temperature 512 over a ramp time 514. The cure stage 504 then controls the curing device 52 to hold the desired cure temperature 512 for a cure time 516. However, as discussed above, problems may arise in the execution of the curing cycle 500 that affect the actual temperature during the ramp and cure stages. Accordingly, the system 400 senses temperature feedback 518 to evaluate the actual temperature against the desired temperature profile of the curing cycle 500. For example, the system 400 may evaluate the control-responsiveness of the curing cycle 500 at the end of the ramp stage 502. If a temperature-control problem is identified by the temperature feedback, then the system 400 may provide a loop-break duration or time 520 for the temperature controls to attain the desired cure temperature 512 in the cure stage 504. However, as indicated by the temperature feedback 518, a temperature-control problem does not exist in the illustrated ramp and cure stages 502 and 504.

Accordingly, the curing cycle 500 proceeds to the ramp stage 506, which transmits one or more commands to the curing device 52 to increase the temperature from the cure temperature 512 to another cure temperature 522 over a ramp time 524. Under normal operating conditions, the cure stage 508 would then hold the desired cure temperature 522 for a cure time 526. However, in the illustrated operating condition, the temperature feedback 518 indicates an over-bake temperature-control problem as the curing cycle 500 completes the ramp stage 506 and begins the cure stage 508. The system 400 identifies this over-bake temperature control problem by evaluating the control-responsiveness of the curing cycle 500 at the end 528 of the ramp stage 506. For example, the system 400 may provide a loop-break duration or time 530 for the temperature controls to attain the desired cure temperature 522 in the cure stage 508. Given the failure of the controls to decrease or level off the temperature to the desired cure temperature 522 within the loop-break duration or time 420, a loop-break control of the system 400 responds by terminating the curing cycle 500 at a loop-break 532.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A system for curing a finish coating, comprising:
an infrared curing device; and
a closed-loop control coupled to the infrared curing device and having a loop-break adapted to terminate a cure cycle if temperature feedback indicates an unresponsive over-bake or under-bake condition.

2. The curing device of claim 1, wherein the closed-loop control comprises a temperature sensor.

3. The curing device of claim 2, wherein the temperature sensor comprises an optical pyrometer aimed at the finish coating.

4. The curing device of claim 2, wherein the temperature sensor is disposed on an object having the finish coating

5. The curing device of claim 1, comprising a positioning mechanism coupled to the infrared curing device.

6. The curing device of claim 5, wherein the positioning mechanism comprises an adjustable arm.

7. The curing device of claim 6, wherein the adjustable arm is coupled to a floor mount.

8. The curing device of claim 6, wherein the adjustable arm is coupled to an overhead mount.

9. The curing device of claim 6, wherein the adjustable arm is movably coupled to a rail mechanism.

10. A curing system, comprising:
a positioning mechanism;
an infrared heater coupled to the positioning mechanism;
a temperature sensor adapted to provide curing temperature feedback from a target of the infrared heater; and
a loop-break control coupled to the infrared heater and adapted to terminate a cure cycle if the curing temperature feedback indicates an unresponsive over-bake or under-bake condition.

11. The system of claim 10, wherein the positioning mechanism comprises an adjustable arm.

12. The system of claim 10, wherein the positioning mechanism comprises a rail mechanism.

13. The system of claim 10, wherein the infrared heater comprises a plurality of infrared heater units.

14. The system of claim 10, wherein the temperature sensor is disposed on the target.

15. The system of claim 10, wherein the temperature sensor comprises a pyrometer aimed at the target.

16. The system of claim 15, wherein the pyrometer comprises an infrared pyrometer.

17. The system of claim 15, wherein the pyrometer comprises a targeting mechanism.

18. The system of claim 17, wherein the targeting mechanism comprises a laser targeting device.

19. A method of curing a surface material, comprising:
radiating infrared heat toward the surface material based on a curing cycle;
obtaining temperature feedback from the surface material;
breaking the curing cycle if the temperature feedback indicates an unresponsive over-bake or under-bake condition.

20. The method of claim 19, wherein radiating infrared heat comprises aiming at least one infrared heater toward the surface material.

21. The method of claim 19, wherein radiating infrared heat comprises moving at least one infrared heater to a position adjacent the surface material.

22. The method of claim 21, wherein moving comprises positioning the at least one infrared heater with an adjustable arm.

23. The method of claim 21, wherein moving comprises positioning the at least one infrared heater along a rail mechanism.

24. The method of claim 19, wherein obtaining temperature feedback comprises locally obtaining a temperature reading at the surface material.

25. The method of claim 19, wherein obtaining temperature feedback comprises remotely obtaining a temperature reading.

26. The method of claim 25, wherein remotely obtaining a temperature reading comprises sensing the temperature reading with an infrared pyrometer.

27. The method of claim 19, wherein breaking the curing cycle comprises terminating the curing cycle if the over-bake or under-bake condition is unresponsive to controls for a desired response time.

28. A coating cured by the method of claim 19.

29. A filler cured by the method of claim 19.

30. A film cured by the method of claim 19.

31. A decal cured by the method of claim 19.

32. A computer executable program comprising:
at least one machine readable medium;
computer code stored on the at least one machine readable medium comprising instructions for radiating infrared heat toward a surface material according to a curing cycle, analyzing temperature feedback from the surface material, and breaking the curing cycle if the temperature feedback indicates an unresponsive over-bake or under-bake condition.
